(19) United States
(12) Patent Application Publication
(10) Pub. No.: US 2013/0329214 A1
(43) Pub. Date: Dec. 12, 2013

(54) APPLICATION OF SPECTRAL LINEWIDTH VARIATION USING OPTICAL FILTER

(71) Applicant: NATIONAL TAIWAN UNIVERSITY OF SCIENCE AND TECHNOL, Taipei (TW)

(72) Inventor: Shih-Hsiang Hsu, New Taipei City (TW)

(73) Assignee: National Taiwan University of Science and Technology, Taipei (TW)

(21) Appl. No.: 13/686,924

(22) Filed: Nov. 28, 2012

(30) Foreign Application Priority Data
Jun. 7, 2012 (TW) 101120525

(51) Int. Cl. G01N 21/25

(52) U.S. Cl. CPC G01N 21/255
USPC 356/39; 356/402

(57) ABSTRACT

The spectral linewidth variation of the light signal passing through the optical filter is employed to determine or evaluate the property of the analyte sample. By way of the optical filter, the light signal passing through the optical filter is affected by the analyte sample placed in the optical filter and the property of the analyte sample is determined by analyzing the resonating linewidth variation from the optical filter.

### CROSS-REFERENCE TO RELATED APPLICATION

This application claims the priority benefit of Taiwan application serial no. 101120525, filed on Jun. 7, 2012. The entirety of the above-mentioned patent application is hereby incorporated by reference herein and made a part of this specification.

### BACKGROUND OF THE INVENTION

1. Field of the Invention

The present application relates to applications of optical filters. More particularly, the present application relates to the application of spectral linewidth variation using an optical filter.

2. Description of Related Art

In the field of biosensors, optical filters and the associated technologies are widely employed in the biosensors so as to obtain highly sensitive and accurate biosensing results for research purposes or medical analysis and diagnosis.

US Patent Publication No. 2008/0095490 discloses a polymer waveguide resonator device for high-frequency ultrasound detection. The waveguide resonator device has an optical resonator coupled to a straight optical waveguide which serves as input and output ports. Acoustic waves irradiating the waveguide induce strain modifying the waveguide cross-section or other design property. As a consequence, the effective index of optical waves propagating along the resonance ring is modified. That is, by way of the polymer waveguide ring resonator, this device detects the wavelength variation of resonance optical waves through the modification of the waveguide cross-section/property induced by acoustic strain.

U.S. Pat. No. 7,970,244 discloses a fabrication method of an optical ring resonator device. The method forms a waveguide ring resonator on a semiconductor substrate, forms an unoriented electro-optic polymer cladding layer over the ring resonator waveguide, and forms electrodes on the semiconductor substrate. The unoriented electro-optic polymer cladding layer is configured to change the orientation under an applied electric field, and the electrodes are coupled to the optical ring resonator for manipulation of the electric field applied to the oriented electro-optic polymer cladding layer. In short, through the unoriented electro-optic polymer cladding layer over the ring resonator waveguide, the orientation is changed and the wavelength of resonance optical wave is also changed when an electric field is applied.

As described in “Guided-Wave Optical Biosensors” by Passaro et al. and “Overview of Novel Integrated Optical Ring Resonator Bio/chemical Sensors” by Fan et al. in 2007, the sensing applications of the optical ring resonator may be established by using the variation of the resonance wavelength to evaluate the characteristics of the analyte in the ring resonator.

As disclosed in FIG. 26 and the related contexts of the thesis by Vittorio M. N. Passaro et al., a micro race-track resonator, fabricated using polymeric materials, in which the resonance slope has been enhanced by the introduction of two partially reflecting element, has been adopted for biochemical sensing. Exploited configuration produces a Fano-resonant line shape that greatly enhances the device sensitivity. A lowering of detection limit related to glucose concentration measurement is obtainable by increasing the micro cavity quality factor Q. Q value around 20,000 has been estimated for the micro-ring resonator proposed, so this sensor exhibits a detection limit equal to 0.915 mg/dL in glucose concentration measurement (homogeneous sensing) and equal to 250 pg/mm² in spavidin molecule detection (surface sensing). Finally, the capability of this sensor to detect shifts of propagating mode effective index around 10⁻⁷ has been also proved.

On the other hand, the paper by Xudong Fan et al. describes an optical waveguide biosensor. FIG. 21 is directed to the layered structures of the liquid core optical ring resonator (LCORR), the anti-resonant reflecting optical waveguide (ARROW), and the coupling relationships thereof. The LCORR employs a micro-sized glass capillary and the circular cross-section of the capillary forms a ring resonator that supports the whispering gallery modes (WGMs), which has the evanescent field in the core, allowing for repetitive interaction with the analytes carried inside the capillary. Under this anti-resonance condition, the ARROW prevents the light in the core from leaking into the substrate, and in the meantime presents a sufficient evanescent field above the core for the coupling between the ARROW and the LCORR.

For sensing the biological or biochemical characteristics, the wavelength variations of the sensing optical waves in response to the corresponding characteristics are commonly employed. Hence, expensive wavemeters are often needed for measuring the wavelength variations of the resonant optical waves. Additionally, the accuracy of the optical filter in biosensing may be limited by the wavemeter typically having the accuracy of hundreds or tens of picometers.

### SUMMARY OF THE INVENTION

The present application is directed to the application of spectral linewidth variation of the resonator using the optical filter, which is corresponding to the differences in characteristics of the employed analyte sample.

In the present application, a method for determining a property of an analyte sample is provided. Firstly an optical ring resonator is provided. The optical ring resonator includes a signal transmission region, a coupling region and a ring resonance region. After placing the analyte sample in the ring resonance region of the optical ring resonator, a light signal is introduced into the optical ring resonator. A resonating linewidth variation of the optical ring resonator caused by the property of the analyte sample is recorded and is further analyzed to determine the property of the analyte sample that corresponds to the linewidth variation.

According to embodiments of the present invention, the optical ring resonator further comprises a coupler disposed in the coupling region, the light signal is introduced into the signal transmission region, and the light signal is transmitted to the ring resonance region through the coupler. The signal transmission region includes an input port and an output port, the light signal is inputted via the input port to the signal transmission region and is outputted via the output port to the spectrum analyzer.

According to embodiments of the present invention, the spectrum analyzer is an electrical spectrum analyzer.

According to embodiments of the present invention, the analyte sample is able to cause the linewidth variation of the optical ring resonator. The analyte sample may be a solution or mixture of blood glucose, a protein, an antigen or an antibody and the property of the analyte sample is a concentration of the analyte sample.

According to embodiments of the present invention, the optical ring resonator includes a silicon wire waveguide.

In order to make the above and other features and advantages of the present invention more comprehensible, embodiments accompanied with figures are described in detail below.

### BRIEF DESCRIPTION OF THE DRAWINGS

FIG. 1 is a schematic view of an optical ring resonator structure according to an embodiment of the present invention.

FIG. 2 is a schematic cross-sectional view of a portion of the optical ring resonator having the silicon-wire waveguide.

FIG. 3 is a flow chart schematically illustrating the application steps for using the optical ring resonator according to embodiment(s) of the present invention.

FIG. 4 is a transmittivity spectrum of the optical ring resonator for different concentrations of blood glucose contents according to an embodiment of the present invention.

FIG. 5 is a graph showing the relationship of the linewidth of the optical ring resonator versus the effective index of the glucose solution.

Common reference numerals are used throughout the drawings and the detailed description to indicate the same elements. The present invention will be more apparent from the following detailed description taken in conjunction with the accompanying drawings.

### DESCRIPTION OF EMBODIMENTS

The following embodiments relate to the applications of spectral linewidth variation using the optical ring resonator as an example of the optical filter. However, the optical filter applicable for the present invention is not limited to the exemplary embodiments provided herein. The linewidth variation corresponding to the characteristics differences of the analyte is employed for analyte characterization.

The optical power exiting from the output port of optical ring resonator can be expressed by Transmittance T:

$$T ( φ ) = \frac{K + {η}^{2} - 2 η \sqrt{K} cos φ}{1 + {η}^{2} K - 2 η \sqrt{K} cos φ}$$

$$φ = 2 π f τ ;$$

$$τ = \frac{nL}{c}$$

wherein K is the coupling intensity of the coupling region of the optical ring resonator, η is the transmission loss of the resonant ring area, f is the light frequency, n is the effective index of the ring waveguide, L is the length of the ring waveguide, and c is the speed of light wave.

From the above formulation, the effective refractive index of the ring waveguide n affects the output optical power. Further analysis reveals that the spectral linewidth is highly sensitive to certain properties. The present embodiment employs the spectral linewidth variation of the optical ring resonator corresponding to the characteristics differences of the analyte for analyte characterization.

In one embodiment, the optical ring resonator is fabricated with waveguides, such as silicon wire waveguide or optical fibers. Although silicon wire waveguide is used as an example in this embodiment, the scope of this invention is not limited by this example.

In this embodiment, biochips are used as examples. However, the linewidth variation is merely used for the measurements of one or more analytes in biochips, and the method or mechanism of this invention may be applied for measuring or evaluating any analyte that is able to cause the linewidth variation of the optical ring resonator.

Biochips are detection devices minimized based on principles of molecular biology, genetic informatics and analytical chemistry. Generally, biochips are high technology devices fabricated by using silicon wafers, glass or polymer materials as the substrate and combined with micro-electromechanical technology or other precision-made technology. With respect to detection devices based on conventional bio-analysis, biochips have advantages such as faster detection rate, lower operation cost, and higher detection accuracy.

Silicon has been constantly applied as a valuable electronic material. When compared with the wide application of silicon in electronic circuits, the optoelectronic technology utilizes various materials for lightening, optical waveguide, light modulation and detection. Due to the low optical loss property of silicon, numerous studies have been focused on bringing out silicon optical applications. The ultimate goal is to utilize silicon as the common substrate for the optoelectronic materials to integrate the optical devices and the electronic circuits. Silicon on insulator (SOI) is a successful optical application of silicon. In addition to the highly developed and mature fabrication technologies of CMOS, the high manufacture throughput properties, low optical loss in the communication wavelength, and the large effective index difference between the core and cladding layers, the extra oxide insulating layer under the silicon chips may lower the power consumption, reduce the current loss and increase the processing speed of the circuit. The SOI technology may be applied in high speed circuits for energy saving and lowering costs, and to integrate the passive devices and active optoelectronic devices in smart integrated circuits.

In this embodiment, the SOI based optical ring resonator is applied as the energy-saving device, providing low energy consumption and low operation costs, for biomedical applications.

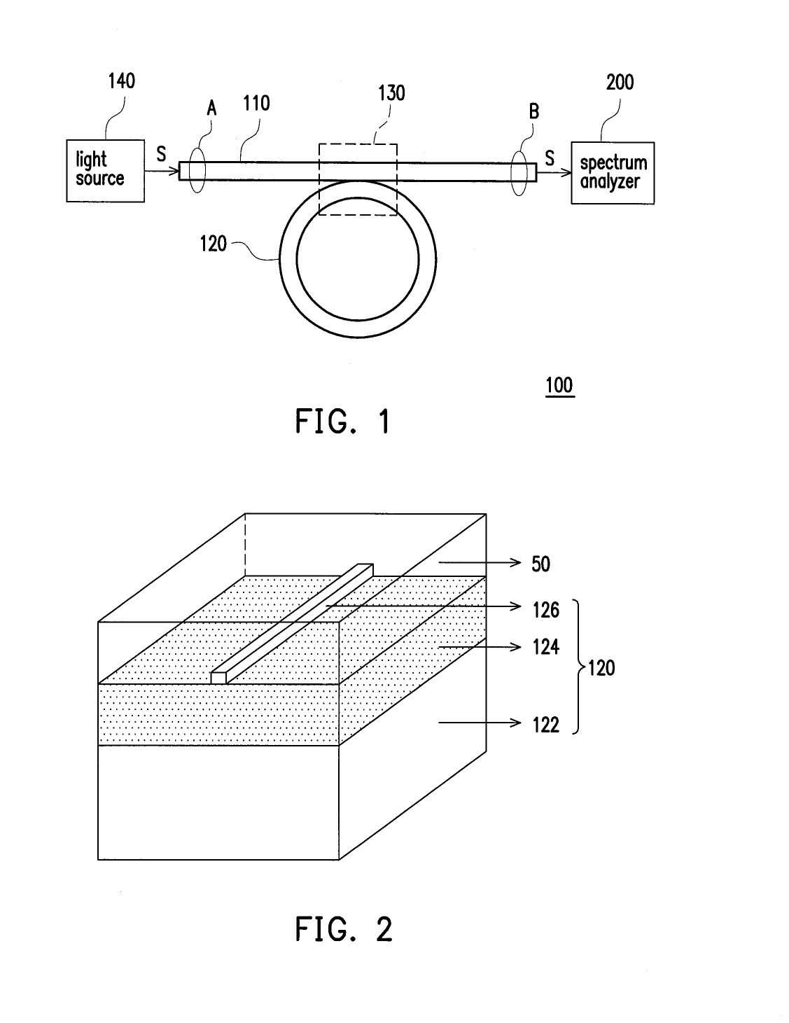

FIG. 1 is a schematic view of an optical ring resonator structure according to an embodiment of the present invention. Referring to FIG. 1, the optical ring resonator 100 includes a signal transmission region 110, a ring resonance region 120 and a coupling region 130. The signal transmission region 110 includes an input port A and an output port B. The light signal S is outputting from the wavelength adjustable light source 140, through the input port A into the signal transmission region 110, outputting by the output port B and then entering the spectrum analyzer 200. The analyte is placed in the ring resonance region 120 for characterization.

In the embodiment, the spectrum analyzer 200 may be an electrical spectrum analyzer, for example. The electrical spectrum analyzer may have sensitivities reaching 1×10⁻⁹ RIU (refractive index units), much higher than the wavemeter with sensitivities of 1×10⁻⁵ RIU. In this embodiment, the coupling region 130 may use optical coupler, for example, for coupling the signal transmission region 110 and the ring resonance region 120, so that light signal S enters the ring resonance region 120 via the optical coupler. As the analyte is placed in the ring resonance region 120, light signal S entering the ring resonance region 120 is affected by certain property of the analyte and the wavelength and linewidth of the resonator change in response to the analyte. The light signal S outputted by the output port B and entering the spectrum analyzer is analyzed to determine the linewidth variation, in order to evaluate the corresponding property of the analyte.

FIG. 2 is a schematic cross-sectional view of a portion of a silicon-wire waveguide based optical ring resonator. The optical resonance region 120 of the optical ring resonator 100 is fabricated with the SOI structure. Referring to FIG. 2, the optical waveguide of the optical resonance region 120 is a silicon-wire waveguide having silicon wire 126 formed on the silicon oxide insulator 124 and above the silicon substrate 122. The small size of the silicon wire waveguide allows prospective application in various aspects. The analyte sample 50, in a form of a cladding layer, is located on top of the silicon wire 126 and the insulator 124 and covers the silicon wire 126 and the insulator 124.

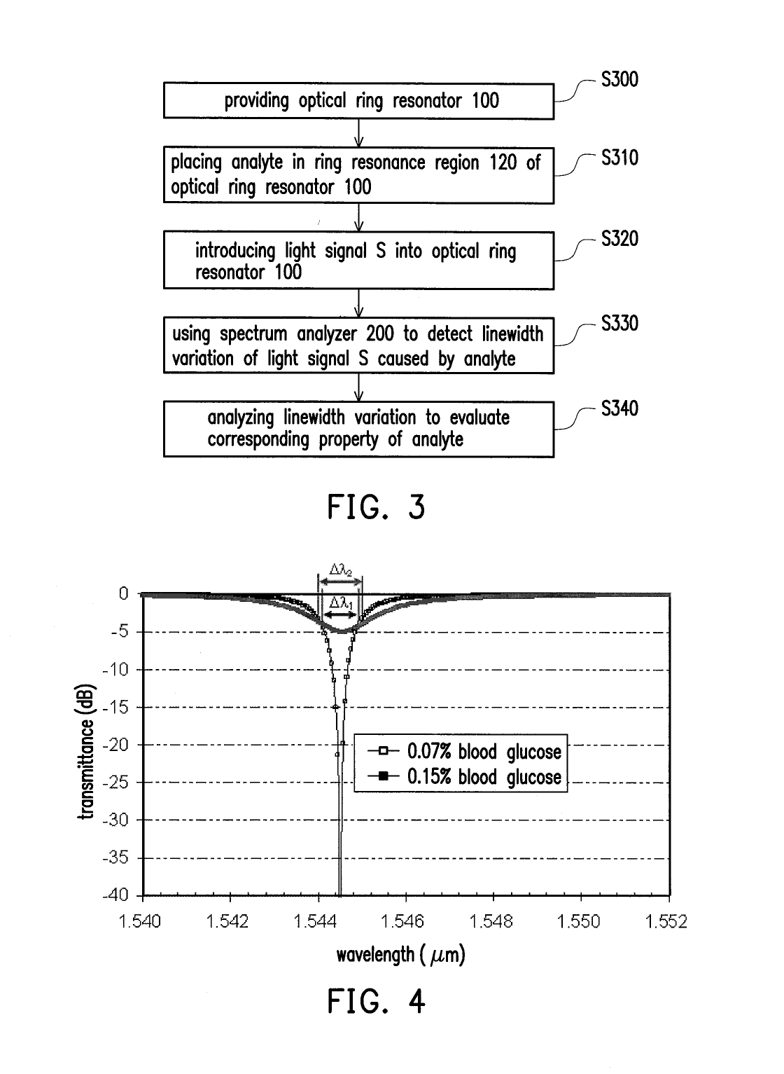

FIG. 3 is a flow chart schematically illustrating the application steps for using the optical ring resonator according to embodiment(s) of the present invention. The optical ring resonator may be fabricated by the silicon on insulator technology. The SOI technology makes the development of compact, light and low-cost optoelectronic biochips having rapid and accurate bio-analytical capabilities possible. Taking the effective index of the analyte sample being 1.3 for example, the thickness of the SOI optical waveguide should be miniaturized to sub-micron levels, in order to enhance the sensitivity and be compatible with the CMOS processes. The biochips having such silicon wire waveguide are responsive enough to reliably determine or detect the contents and the concentration thereof for analytes, such as glucose, antibody, antigen or protein, in the blood samples or other body fluids.

Referring to FIGS. 1 and 3, in Step S300, an optical ring resonator 100 of FIG. 1 is provided. The optical ring resonator 100 is fabricated by the silicon on insulator technology. In Step S310, an analyte sample to be determined is placed in the ring resonance region 120. The analyte sample may be a biochemical compound or a biological material, for example. In Step S320, a light signal S is lead into the optical ring resonator 100. In Step S330, the electrical spectrum analyzer 200 is used to detect and determine the resonator linewidth variation caused by the analyte sample. In Step S340, the linewidth variation is further analyzed to evaluate a particular property of the analyte sample that corresponds to the resonator linewidth variation. Such property is a physical property of the analyte that is able to affect the resonating effect through the light signal passing the optical ring resonator by the coupling region. For example, the analyte may be glucose, protein, antibody or antigen and the property of the analyte sample may be the concentration of these biochemical compound(s).

Taking blood glucose as an example of the analyte sample, the glucose concentration is used for evaluation. FIG. 4 is a transmittance spectrum of the optical ring resonator for different concentrations of blood glucose contents according to an embodiment of the present invention. Referring to FIG. 4, different concentrations of blood glucose cause different resonating linewidth variation (Δλ) by the light signal passing through the optical ring resonator 100. In FIG. 4, when compared with 0.15 wt % blood glucose sample (the sample having 0.15% by weight of blood glucose), 0.07 wt % blood glucose sample causes a smaller linewidth variation (i.e. Δλ₁<Δλ₂). Hence, the optical ring resonator 100 of this invention may be applied to determine the concentration or the content changes of the biochemical compound by measuring the linewidth variation of the optical ring resonator.

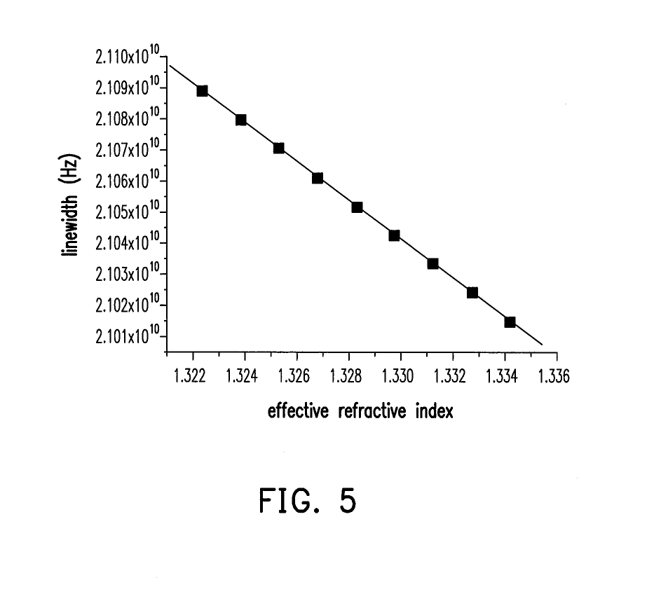

In this embodiment, the silicon wire waveguide of 0.3 micron thickness is used as an example, when the blood glucose solution covers the silicon wire waveguide based optical ring resonator 100, the effective index of the optical ring resonator 100 will be affected by the blood glucose solution having its own effective index. The effective index of the blood glucose solution varies along with the glucose concentration of the blood glucose solution. FIG. 5 is a graph showing the relationship of the linewidth of the optical ring resonator versus the effective refractive index of the glucose solution. From FIG. 5, the glucose concentration ranges from 70 mg/dL (with the effective refractive index of 1.3222943) to 150 mg/dl (with the effective refractive index of 1.3341735), the resonating linewidth varies when the effective index varies. By way of linear regression calculations, the slope of the regression line is obtained as 5.7×10⁹ Hz/RIU. If the measurement of spectrum analyzer can provide up to 5 Hz of frequency accuracy, the measuring accuracy of the optical ring resonator under this linewidth can reach about 1×10⁻⁹ RIU.

The examples listed herein are merely for illustrations and not to limit the scope of the present invention.

To sum up, based on the application of the optical ring resonator structure of the present embodiment, the linewidth variation may be used to evaluate the physical property of the analyte or sample. The production costs for the optical ring resonator characteristics may be lowered by using low-cost electrical spectrum analyzer and the sensitivity is also increased.

While the invention has been described and illustrated with reference to specific embodiments thereof, these descriptions and illustrations do not limit the invention. It should be understood by those skilled in the art that various changes may be made and equivalents may be substituted without departing from the true spirit and scope of the invention as defined by the appended claims. The illustrations may not be necessarily being drawn to scale. There may be distinctions between the artistic renditions in the present disclosure and the actual apparatus due to manufacturing processes and tolerances. There may be other embodiments of the present invention which are not specifically illustrated. The specification and the drawings are to be regarded as illustrative rather than restrictive. Modifications may be made to adapt a particular situation, material, composition of matter, method, or process to the objective, spirit and scope of the invention. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. A method for determining a property of an analyte sample, comprising:
providing an optical ring resonator, wherein the optical ring resonator includes a signal transmission region, a coupling region and a ring resonance region;
placing the analyte sample in the ring resonance region of the optical ring resonator;
introducing a light signal into the signal transmission region of the optical ring resonator;
using a spectrum analyzer to detect a linewidth variation of the optical ring resonator affected by the property of the analyte sample; and
analyzing the linewidth variation to determine the property of the analyte sample that corresponds to the linewidth variation.

2. The method as claimed in claim 1, wherein the optical ring resonator further comprises a coupler disposed in the coupling region, the light signal is introduced into the signal transmission region, and the light signal is transmitted to the ring resonance region through the coupler.

3. The method as claimed in claim 2, wherein the signal transmission region includes an input port and an output port, the light signal is inputted via the input port to the signal transmission region and is outputted via the output port to the spectrum analyzer.

4. The method as claimed in claim 1, wherein the spectrum analyzer is an electrical spectrum analyzer.

5. The method as claimed in claim 1, wherein the linewidth variation of the optical ring resonator is a resonating linewidth variation, and the property of the analyte sample is a physical property able to affect the resonating linewidth variation of the optical ring resonator through the light signal.

6. The method as claimed in claim 5, wherein the analyte sample is a solution or mixture of blood glucose, a protein, an antigen or an antibody and the property of the analyte sample is a concentration of the analyte sample.

7. The method as claimed in claim 1, wherein the optical ring resonator is made by the waveguide technology.
